(19) United States
(12) Patent Application Publication
(10) Pub. No.: US 2014/0021757 A1
(43) Pub. Date: Jan. 23, 2014

(54) SAFETY BELT ASSEMBLY AND CHILD SAFETY SEAT THEREWITH

(71) Applicant: Xiao-Long Mo, Dongguan (CN)

(72) Inventor: Xiao-Long Mo, Dongguan (CN)

(21) Appl. No.: 13/949,165

(22) Filed: Jul. 23, 2013

(30) Foreign Application Priority Data
Jul. 23, 2012 (CN) 201210255712.9

(51) Int. Cl. B60R 22/10; B60N 2/26

(52) U.S. Cl. CPC B60R 22/105; B60N 2/265
USPC 297/250.1; 297/468

(57) ABSTRACT

The present invention provides a safety belt assembly and a child safety seat therewith. The safety belt assembly includes a safety belt, and a buffer mechanism installed on the safety belt. The buffer mechanism is for detachably connecting two parts of the safety belt in a longitudinal direction so as to form a folding portion of the safety belt. When a pulling force is applied to the safety belt, the buffer mechanism absorbs a part of the pulling force to separate the two parts of the safety belt. It has advantages of simple structure, improved reliability, easy operation and low cost.

### BACKGROUND OF THE INVENTION

1. Field of the Invention

The present invention relates to a safety belt assembly and a child safety seat therewith, and more specifically, to a safety belt assembly and a child safety seat with simple structure and low cost.

2. Description of the Prior Art

As for a conventional design of a safety belt for a child safety seat, one end of the safety belt is generally fixed, and the other end of the safety belt is buckled by a buckle on a seat. When a child seats in the seat and a sudden emergent braking or impact occurs, the child's body would continue to move forward due to inertia and the safety belt can tightly pull the child' s body, thereby preventing the child from flying outwards. However, the conventional safety belt has no flexibility so that the sudden pulling force applied on the child is directly affected by impact. Besides, the child's bones have not developed fully and cannot withstand so strong impact, resulting in vulnerability. Generally, since the safety belt crosses the chest to the shoulder, the child's head still moves forwards due to inertia although the safety belt prevents the body from flying outwards. It might hurt the child's breastbone and backbone. In order to reduce the harm to children, it usually disposes a buffer component on the safety belt. However, the conventional buffer component has complicated structure, inconvenient operation and high cost, which cannot meet people's requirements. Therefore, there is a need to design a safety belt assembly with simple structure, easy operation and low cost.

### SUMMARY OF THE INVENTION

A purpose of the present invention is to provide a safety belt assembly and a child safety seat with simple structure, improved reliability, easy operation and low cost, to solve the problems mentioned above.

In order to achieve above purposes, the present invention is to provide a safety belt assembly including a safety belt, and a buffer mechanism installed on the safety belt. The buffer mechanism is for detachably connecting two parts of the safety belt in a longitudinal direction so as to form a folding portion of the safety belt. When a pulling force is applied to the safety belt, the buffer mechanism absorbs a part of the pulling force to separate the two parts of the safety belt.

Preferably, the buffer mechanism comprises a sewing thread for sewing the two parts of the safety belt in the longitudinal direction.

Preferably, the buffer mechanism comprises a male buckle and a female buckle for detachably buckling with each other.

Preferably, the buffer mechanism is a Velcro fastener comprising a male Velcro strip with hooks and a female Velcro strip with loops for detachably attaching with each other.

Preferably, the safety belt is a fabric safety belt.

Preferably, the buffer mechanism is installed on a center of the safety belt.

In order to achieve above purposes, the present invention is further to provide a child safety seat. The child safety seat includes a seat body, a cross belt installed on a front side of the seat body, a belt buckle, a safety belt adjuster installed on the front side of the seat body, and two shoulder belts. One end of each shoulder belt is connected to the cross belt, and the other end of each shoulder belt is connected to the belt buckle. The child safety seat further includes a safety belt assembly installed between the belt buckle and the safety belt adjuster. The safety belt assembly includes a safety belt, and a buffer mechanism installed on the safety belt. The buffer mechanism is for detachably connecting two parts of the safety belt in a longitudinal direction so as to form a folding portion of the safety belt. When a pulling force is applied to the safety belt, the buffer mechanism absorbs a part of the pulling force to separate the two parts of the safety belt.

In order to achieve above purposes, the present invention is further to provide a child safety seat. The child safety seat includes a seat body, a cross belt installed on a front side of the seat body, a belt buckle, a safety belt adjuster installed on the front side of the seat body, and two shoulder belts. One end of each shoulder belt is connected to the cross belt, and the other end of each shoulder belt is connected to the belt buckle. The child safety seat further includes two safety belt assemblies. Each safety belt assembly is installed between the belt buckle and the corresponding shoulder belt. Each safety belt assembly includes a safety belt, and a buffer mechanism installed on the safety belt. The buffer mechanism is for detachably connecting two parts of the safety belt in a longitudinal direction so as to form a folding portion of the safety belt. When a pulling force is applied to the safety belt, the buffer mechanism absorbs a part of the pulling force to separate the two parts of the safety belt.

The present invention disposes the buffer mechanism on the safety belt to detachably connect two parts of the safety belt in the longitudinal direction, so as form the folding portion of the safety belt. As the safety belt is pulled by the pulling force in excess of a critical threshold, the buffer mechanism can absorb impact and then separate the two parts of the safety belt to extend the folding portion, so as to tighten the safety belt again for securing the child in the seat body. It has advantages of simple structure, improved reliability, easy operation and low cost.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 and FIG. 2 are schematic drawings of a child safety seat in different views according to a first embodiment of the present invention.

FIG. 3 is a diagram of a safety belt assembly according to the first embodiment of the present invention.

FIG. 4 is a diagram of a safety belt assembly according to a second embodiment of the present invention.

FIG. 5 is a diagram of a safety belt assembly according to a third embodiment of the present invention.

FIG. 6 is a schematic drawing of the child safety seat according to a fourth embodiment of the present invention.

### DETAILED DESCRIPTION

In the following detailed description of the preferred embodiments, reference is made to the accompanying drawings which form a part hereof, and in which is shown by way of illustration specific embodiments in which the invention maybe practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. Accordingly, the drawings and descriptions will be regarded as illustrative in nature and not as restrictive.

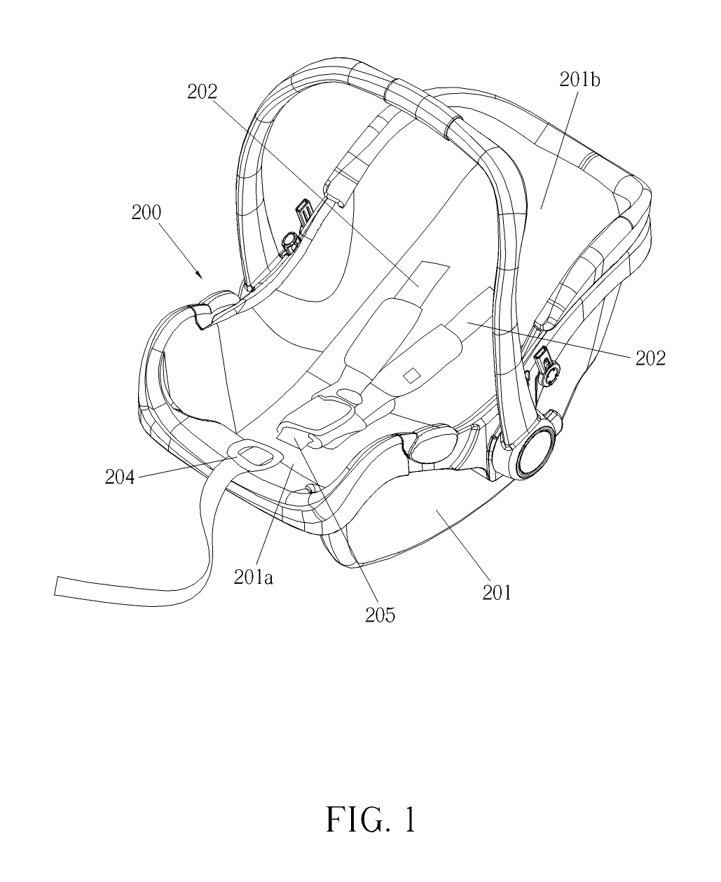

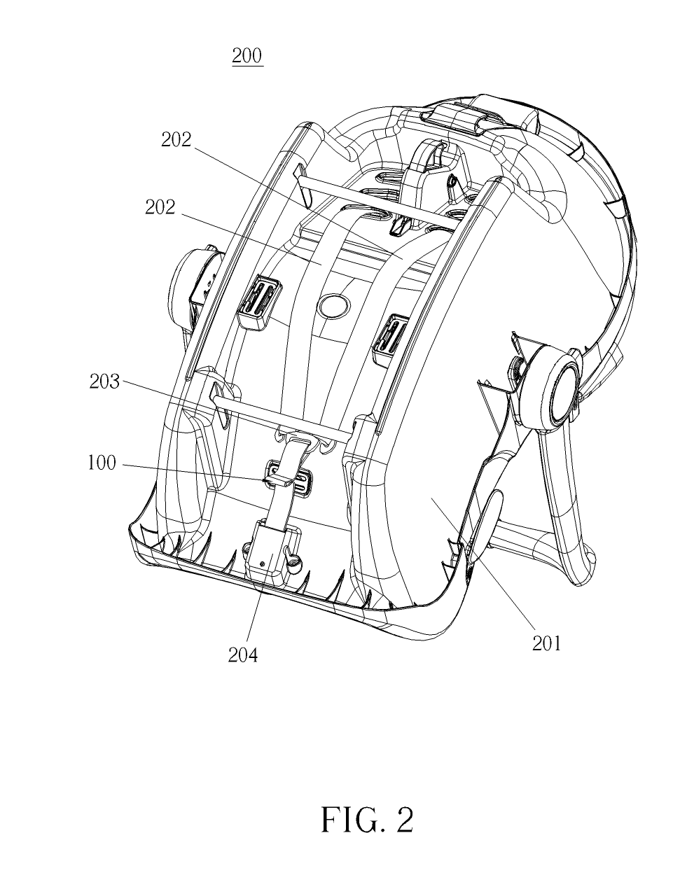

Please refer to FIG. 1 and FIG. 2. FIG. 1 and FIG. 2 are schematic drawings of a child safety seat 200 in different views according to a first embodiment of the present invention. The child safety seat 200 includes a seat body 201, two shoulder belts 202, a belt buckle 203, a safety belt adjusted 204 and a cross belt 205. The cross belt 205 and the safety belt adjusted 204 are installed on a front side of the seat body 201. One end of each shoulder belt 202 is connected to the cross belt 205, and the other end of each shoulder belt 205 passes through a backrest 201b of the seat body 201 backwards to be connected to the belt buckle 203 on a back of the seat body 201. The child safety seat 200 further includes a safety belt assembly 100 installed between the belt buckle 203 and the safety belt adjuster 204. An end of the safety belt assembly 100 is fixed with the belt buckle 203, and the other end of the safety belt assembly 100 is connected to the safety belt adjustor 204 and protrudes out of a seat base 201a of the seat body 201. A length of each shoulder belt 202 can be adjusted by pulling the other end of the safety belt assembly 100.

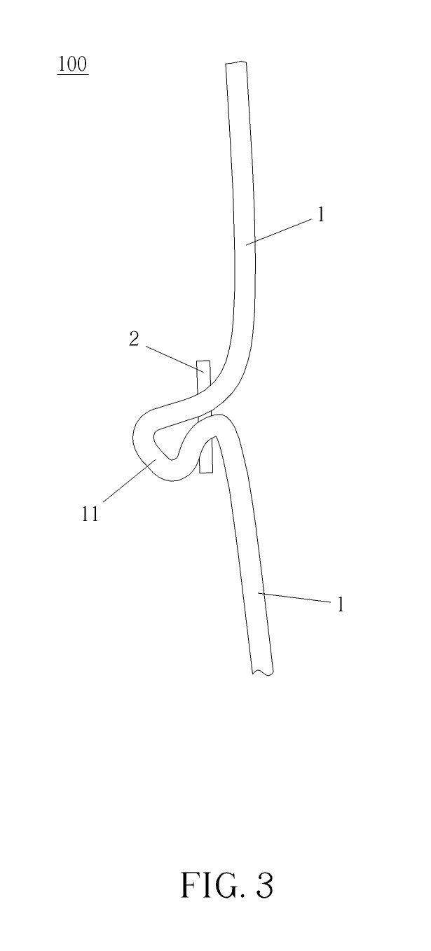

Please refer to FIG. 3. FIG. 3 is a diagram of the safety belt assembly 100 according to the first embodiment of the present invention. The safety belt assembly 100 includes a safety belt 1 and a buffer mechanism 2 installed on the safety belt 1. The safety belt 1 can be a fabric safety belt. The buffer mechanism 2 is for detachably connecting two parts of the safety belt 1 in a longitudinal direction so as to form a folding portion 11 of the safety belt 1. The buffer mechanism 2 can be installed on a center of the safety belt 1. When a pulling force is applied to the safety belt 1, the buffer mechanism 2 can absorb a part of the pulling force to separate the two parts of the safety belt 1, so as to extend the folding portion 11 for tightening the safety belt 1.

Preferably, the buffer mechanism 2 is installed on the center of the safety belt 1, and the buffer mechanism 2 includes at least one sewing thread for sewing the two parts of the safety belt 1 in the longitudinal direction of this embodiment. The part between the sewed two parts of the safety belt 1 is formed to be the folding portion 11. When a child seats in the seat body 201 and a sudden emergent braking or impact occurs, the child's body would continue to move forward due to inertia and the shoulder belts 202 can tightly pull the child's body, thereby preventing the child from flying outwards. After the safety belt 1 is pulled by the pulling force in excess of sewing strength of the sewing thread, the sewing thread would break. During the above-mentioned process, the buffer mechanism 2 can absorb a part of the pulling force, so as to prevent the harm to the child due to reaction force provided by the shoulder belts 202. The buffer mechanism 2 not only can connect the two parts of the safety belt 1 to form the folding portion 11 of the safety belt 1, but also can absorb the impact and then be broken to tighten the safety belt 1 again for securing the child in the seat body 201. Besides, the buffer mechanism 2 can include a plurality of sewing threads to provide multiple cushions and protections. It has advantages of simple structure, easy manufacture and low cost.

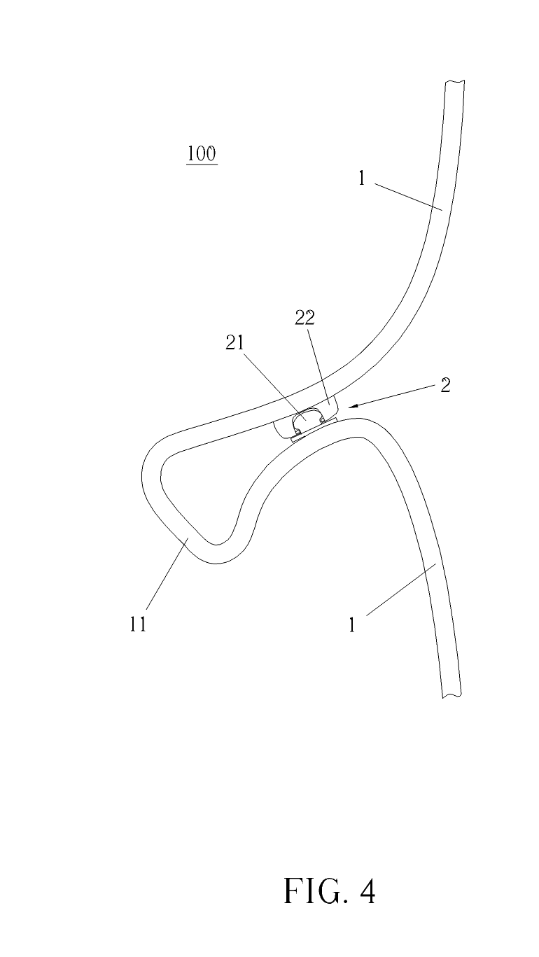

Please refer to FIG. 4. FIG. 4 is a diagram of the safety belt assembly 100′ according to a second embodiment of the present invention. The safety belt assembly 100′ of this embodiment also can be implemented in the child safety seat 200. The safety belt assembly 100′ includes a safety belt 1′ and a buffer mechanism 2′. The buffer mechanism 2′ includes a male buckle 21′ and a female buckle 22′ respectively installed on the safety belt 1′ and for detachably buckling with each other. When the child seats in the seat body 201 and the sudden emergent braking or impact occurs, the child's body would continue to move forward due to inertia and the shoulder belts 202 can tightly pull the safety belt 1′ and the child's body, thereby preventing the child from flying outwards. After the safety belt 1′ is pulled by the pulling force by the shoulder belts 202 in excess of a bucking force of the male buckle 21′ and the female buckle 22′, the male buckle 21′ and the female buckle 22′ would separate from each other. During the above-mentioned process, the safety belt assembly 100′ can absorb a part of the pulling force, so as to prevent the harm to the child due to reaction force provided by the shoulder belts 202. The male buckle 21′ and the female buckle 22′ not only can connect the two parts of the safety belt 1′ to form the folding portion 11′ of the safety belt 1′, but also can absorb the impact and then separate from each other so as to extend the folding portion 11′ for tightening the safety belt 1′ again, thereby securing the child in the seat body 201. The male buckle 21′ and the female buckle 22′ can be repeatedly used. It has advantages of simple structure, easy manufacture and low cost. Besides, there can be a plurality of sets of the male buckle 21′ and the female buckle 22′ for the safety belt 1′ to provide multiple cushions and protections.

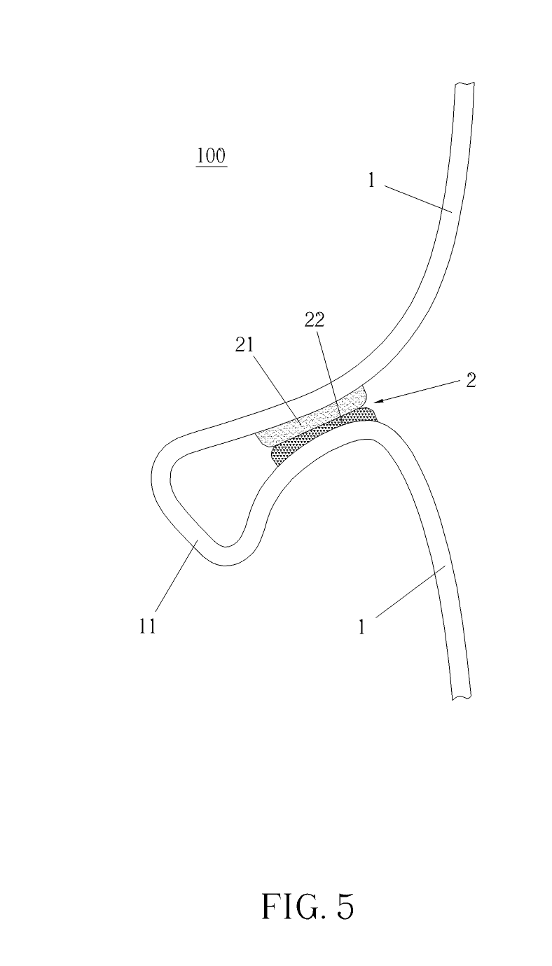

Please refer to FIG. 5. FIG. 5 is a diagram of the safety belt assembly 100″ according to a third embodiment of the present invention. The safety belt assembly 100″ of this embodiment also can be implemented in the child safety seat 200. The safety belt assembly 100″ includes a safety belt 1″ and a buffer mechanism 2″. The buffer mechanism 2″ is a Velcro fastener including a male Velcro strip 22″ with hooks and a female Velcro strip 21″ with loops, respectively installed on the safety belt 1″ for detachably attaching with each other. When the child seats in the seat body 201 and the sudden emergent braking or impact occurs, the child's body would continue to move forward due to inertia and the shoulder belts 202 can tightly pull the safety belt 1″ and the child's body, thereby preventing the child from flying outwards. After the safety belt 1″ is pulled by the pulling force by the shoulder belts 202 in excess of an attaching force of the male Velcro strip 22″ and the female Velcro strip 21″, the male Velcro strip 22″ and the female Velcro strip 21″ would separate from each other. During the above-mentioned process, the safety belt assembly 100″ can absorb a part of the pulling force, so as to prevent the harm to the child due to reaction force provided by the shoulder belts 202. The male Velcro strip 22″ and the female Velcro strip 21″ not only can connect the two parts of the safety belt 1″ to form the folding portion 11″ of the safety belt 1″, but also can absorb the impact and then separate from each other so as to extend the folding portion 11″ for tightening the safety belt 1″ again, thereby securing the child in the seat body 201. The male Velcro strip 22″ and the female Velcro strip 21″ also can be repeatedly used. It has advantages of simple structure, easy manufacture and low cost. Besides, there can be a plurality of sets of the male Velcro strip 22″ and the female Velcro strip 21″ for the safety belt 1″ to provide multiple cushions and protections.

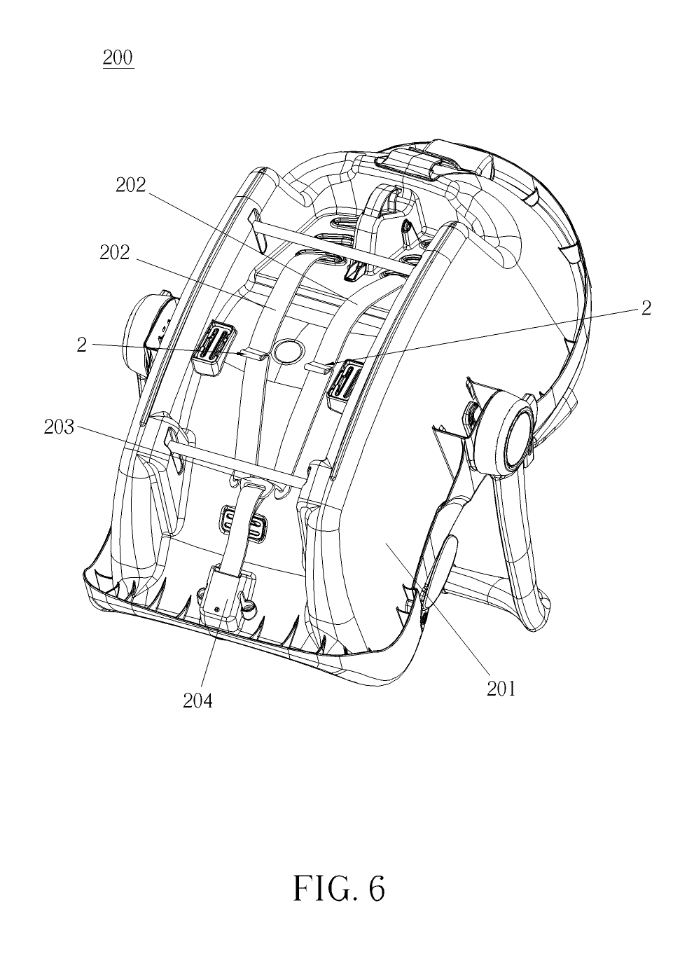

Please refer to FIG. 6. FIG. 6 is a schematic drawing of the child safety seat 200 according to a fourth embodiment of the present invention. In this embodiment, the child safety seat 200 can include the two safety belt assemblies 100. Each safety belt assembly 100 is installed between the belt buckle 203 and the corresponding shoulder belt 202. That is, the two buffer mechanisms 2 are disposed on the two shoulder belts 202 on the back of the seat body 201 respectively. The buffer mechanisms 2 can absorb impact as the shoulder belts 202 are pulled. The operational principle is the same as one of the above-mentioned embodiment, and detailed description is herein not repeated. In addition, the safety belt assembly 100 is not limited to implement in the child safety seat. For example, it also can be implemented in a vehicle chair, and it depends on actual design demands.

In contrast with the prior art, the present invention disposes the buffer mechanism on the safety belt to detachably connect two parts of the safety belt in the longitudinal direction, so as form the folding portion of the safety belt. As the safety belt is pulled by the pulling force in excess of a critical threshold, the buffer mechanism can absorb impact and then separate the two parts of the safety belt to extend the folding portion, so as to tighten the safety belt again for securing the child in the seat body. It has advantages of simple structure, improved reliability, easy operation and low cost.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A safety belt assembly comprising:
a safety belt; and
a buffer mechanism installed on the safety belt, the buffer mechanism being for detachably connecting two parts of the safety belt in a longitudinal direction so as to form a folding portion of the safety belt, wherein when a pulling force is applied to the safety belt, the buffer mechanism absorbs a part of the pulling force to separate the two parts of the safety belt.

2. The safety belt assembly of claim 1, wherein the buffer mechanism comprises at least one sewing thread for sewing the two parts of the safety belt in the longitudinal direction.

3. The safety belt assembly of claim 1, wherein the buffer mechanism comprises a male buckle and a female buckle for detachably buckling with each other.

4. The safety belt assembly of claim 1, wherein the buffer mechanism is a Velcro fastener comprising a male Velcro strip with hooks and a female Velcro strip with loops for detachably attaching with each other.

5. The safety belt assembly of claim 1, wherein the safety belt is a fabric safety belt.

6. The safety belt assembly of claim 1, wherein the buffer mechanism is installed on a center of the safety belt.

7. A child safety seat comprising:
a seat body;
a cross belt installed on a front side of the seat body;
a belt buckle;
a safety belt adjuster installed on the front side of the seat body;
two shoulder belts, one end of each shoulder belt being connected to the cross belt, and the other end of each shoulder belt being connected to the belt buckle; and
a safety belt assembly installed between the belt buckle and the safety belt adjuster, the safety belt assembly comprising:
a safety belt; and
a buffer mechanism installed on the safety belt, the buffer mechanism being for detachably connecting two parts of the safety belt in a longitudinal direction so as to form a folding portion of the safety belt, wherein when a pulling force is applied to the safety belt, the buffer mechanism absorbs a part of the pulling force to separate the two parts of the safety belt.

8. A child safety seat comprising:
a seat body;
a cross belt installed on a front side of the seat body;
a belt buckle;
a safety belt adjuster installed on the front side of the seat body;
two shoulder belts, one end of each shoulder belt being connected to the cross belt, and the other end of each shoulder belt being connected to the belt buckle; and
two safety belt assemblies, each safety belt assembly being installed between the belt buckle and the corresponding shoulder belt, each safety belt assembly comprising:
a safety belt; and
a buffer mechanism installed on the safety belt, the buffer mechanism being for detachably connecting two parts of the safety belt in a longitudinal direction so as to form a folding portion of the safety belt, wherein when a pulling force is applied to the safety belt, the buffer mechanism absorbs a part of the pulling force to separate the two parts of the safety belt.
